(19) United States
(12) Patent Application Publication
(10) Pub. No.: US 2010/0117521 A1
(43) Pub. Date: May 13, 2010

(54) LANTHANOID EMITTER FOR OLED APPLICATIONS

(75) Inventors: Hartmut Yersin, Sinzing (DE); Uwe Monkowius, Linz (AT)

Correspondence Address: CONNOLLY BOVE LODGE & HUTZ, LLP, P O BOX 2207, WILMINGTON, DE, 19899, US

(73) Assignee: MERCK PATENT GmbH Patents & Scientific Information, Darmstadt (DE)

(21) Appl. No.: 12/444,763

(22) PCT Filed: Oct. 11, 2007
(86) PCT No.: PCT/EP07/08856

§ 371 Date: Apr. 8, 2009

(30) Foreign Application Priority Data
Oct. 11, 2006 (DE) 10 2006 048 202.6

(51) Int. Cl. H01J 1/63; C07F 5/00; C09K 11/06

(52) U.S. Cl. 313/504; 534/15; 252/301.16

(57) ABSTRACT

The invention relates to light emitting devices and in particular to organic light emitting devices (OLED). The invention more specifically relates to the use of luminescent lanthanoid complexes as emitters in such devices.

The present invention relates to light-emitting devices and in particular organic light-emitting devices (OLEDs). In particular, the invention relates to the use of luminescent lanthanoid complexes as emitters in such devices.

OLEDs (organic light-emitting devices or organic light-emitting diodes) represent a novel technology which will dramatically change display-screen and illumination technology. OLEDs consist predominantly of organic layers, which are also flexible and inexpensive to manufacture. OLED components can be designed to have large areas as illumination elements, but also to be small as pixels for displays.

An overview of the function of OLEDs is given, for example, in H. Yersin, Top. Curr. Chem. 2004, 241, 1 and in H. Yersin, “Highly Efficient OLEDs with Phosphorescent Materials”, Wiley-VCH 2007.

The function of OLEDs has also been described in C. Adachi et al., Appl. Phys. Lett. 2001, 78, 1622; X. H. Yang et al., Appl. Phys. Lett. 2004, 84, 2476; J. Shinar, “Organic Light-Emitting Devices—A Survey”, AIP-Press, Springer, New York 2004; W. Sotoyama et al., Appl. Phys. Lett. 2005, 86, 153505; S. Okada et al., Dalton Trans., 2005, 1583 and Y. -L. Tung et al., J. Mater. Chem., 2005, 15, 460-464.

Since the first reports on OLEDs (see, for example, Tang et al., Appl. Phys. Lett. 51 (1987) 913), these devices have been developed further, in particular with respect to the emitter materials employed, with, in particular, so-called phosphorescent emitters being of interest recently.

Compared with conventional technologies, such as, for example, liquid-crystal displays (LCDs), plasma displays or cathode ray tubes (CRTs), OLEDs have numerous advantages, such as, for example, a low operating voltage, a flat design, highly efficiently self-illuminating pixels, high contrast and good resolution, as well as the possibility of displaying all colours. Furthermore, an OLED emits light on application of an electric voltage instead of only modulating it. Whereas numerous applications have already been developed for OLEDs and novel areas of application have also been opened up, there is still a demand for improved OLEDs and in particular for improved emitter materials. In particular, problems with long-term stability, thermal stability and chemical stability to water and oxygen occur in the solutions to date. Furthermore, many emitters exhibit only low sublimability. Furthermore, important emission colours are often not available with emitter materials known to date. It is also often impossible to achieve high efficiencies at the same time as high current densities or high luminous densities. Finally, problems exist in the case of many emitter materials with respect to manufacturing reproducibility.

It has furthermore been observed that the light yield of OLEDs comprising organometallic substances, so-called emitters, can be significantly greater than for purely organic materials. Owing to this property, the further development of organometallic materials is of considerable importance. Emitters have been described, for example, in WO 2004/017043 A2 (Thompson), WO 2004/016711 A1 (Thompson), WO 03/095587 (Tsuboyama), US 2003/0205707 (Chi-Ming Che), US 2002/0179885 (Chi-Ming Che), US 2003/186080 A1 (J. Kamatani), DE 103 50 606 A1 (Stöβel), DE 103 38 550 (Bold), DE 103 58 665 A1 (Lennartz).

Lanthanoid compounds have also already been employed as emitter materials. The advantage of lanthanoid compounds is their high colour purity, which is attributable to the narrow line widths of their photo- or electroluminescence. Lanthanoid complexes and the use thereof in OLEDs have been described, for example, in WO 98/55561 A1, WO 2004/016708 A1, WO 2004/058912 A2, EP 0 744 451 A1, WO 00/44851 A2, WO 98/58037 A1 and U.S. Pat. No. 5,128,587 A. However, these compounds, for example the compounds described in WO 98/55561, have the disadvantages which are frequently observed for lanthanoid compounds. On contact with water, decomposition occurs rapidly in the majority of the complexes, with formation of hydroxides and oxides, which causes problems with respect to the long-term stability of the OLEDs. In aqueous solution, the lack of saturation of the coordination sphere of many lanthanoid complexes means that the lanthanoid cation is not adequately screened against coordination to water, which results in decomposition.

It was an object of the present invention to provide novel emitter materials, in particular for OLEDs and novel light-emitting devices, which at least partially overcome the disadvantages of the prior art and which are, in particular, stable to water and air.

This object is achieved in accordance with the invention by a light-emitting device comprising (i) an anode, (ii) a cathode and (iii) an emitter layer arranged between and in direct or indirect contact with the anode and the cathode, comprising at least one complex of the formula (I) or (II)

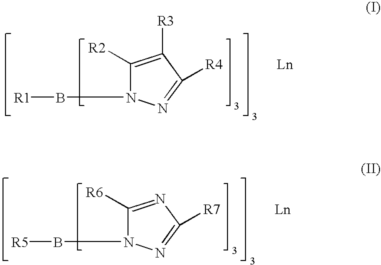

in which

Ln=Ce³⁺, Ce⁴⁺, Pr³⁺, Pr⁴⁺, Nd³⁺, Nd⁴⁺, Pm³⁺, Sm³⁺, Sm²⁺, Eu³⁺, Eu²⁺, Gd³⁺, Tb³⁺, Tb⁴⁺, Dy³⁺, Dy⁴⁺, Ho³⁺, Er³⁺, Tm³⁺, Tm²⁺, Yb³⁺, Yb²⁺ or Lu³⁺,

R1=a pyrazolyl, triazolyl, heteroaryl, alkyl, aryl, alkoxy, phenolate, amine or amide group, which may be substituted or unsubstituted, or

R⁵=R¹ or H, and

R², R³, R⁴, R⁶, R⁷=H, halogen or a hydrocarbon group, which may optionally contain heteroatoms, in particular alkyl, aryl or heteroaryl. In order to increase the volatility of the compounds, the groups R²-R⁷ may be fluorinated.

Surprisingly, it has been observed that the use according to the invention of the complexes of the formula (I) or (II) in the emitter layer enables light-emitting devices to be obtained which have excellent properties. The radical R¹ which is different from hydrogen on the boron atom of the ligand enables air-stable and soluble Ln complexes to be obtained in accordance with the invention (substances of the formula (I)). It has been observed in accordance with the invention that the presence of the radical R¹ on the boron atom gives stable complexes, while soluble and water- and air-stable Ln complexes could not be obtained by variation of the substitution pattern on the pyrazolyl group, as described in WO 98/55561, in the presence of a hydrogen atom on the boron. It has furthermore been observed that the desired properties are also obtained if a triazolyl group (compounds of the formula (II)) is used instead of the pyrazolyl group.

The compounds according to the invention are particularly preferably compounds having a homoleptic substitution pattern on the boron atom, in particular since these are the simplest to obtain synthetically. In this case, the compounds have the preferred formulae (Ia) and (IIa).

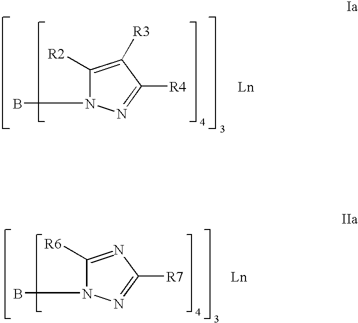

The ligands here are tetrakis(pyrazolyl)borate and tetrakis(triazolyl)borate ligands respectively.

However, R¹ and R⁵ may also represent another organic group, in particular alkyl, aryl, heteroaryl, alkoxy, phenolate, amine or amide groups.

The essential advantage of the compounds according to the invention is their good solubility in virtually all polar solvents, for example in H₂O, MeOH, EtOH, MeCN, CHCl₃, CH₂Cl₂, etc., and their good stability to water and oxygen. The compounds are thus particularly suitable for spin-coating processes, printing processes and ink-jet printing processes. A further essential advantage consists in the simplification of the synthesis of the Ln complexes since there is no need to work under a protective-gas atmosphere and with anhydrous solvents. In addition, the complexes can be varied through substitution or/and modification of the ligands, giving rise to a wide variety of possibilities for the modification and control of the emission properties (for example colour, quantum yield, decay time, etc.).

The invention therefore furthermore relates to complexes of the formula (I) or (II) as described herein.

The light-emitting device according to the invention comprises, as emitter, at least one Ln complex of the formula (I) or (II).

The compounds according to the invention are, in particular, homoleptic complexes in which the borate ligands screen the Ln centre adequately through an at least nine-fold coordination. Decomposition is thus prevented. The substituent R1 or R5 on the boron atom points away from the complex centre, meaning that it does not adversely affect the coordination. Via these substituents, it is possible to control the solubility. Whereas a sparingly soluble complex is obtained for R1=H, as described in the prior art, soluble compounds are obtained for R1 substituents in accordance with the present invention, for example for R1=pyrazolyl. Substances are thus obtained which are highly suitable for wet-chemical processing, which represents a significant technological advantage.

It has been observed in accordance with the invention that compounds of the formula (I) or (II) are eminently suitable as emitter molecules for light-emitting devices and in particular for organic light-emitting devices (OLEDs). The compounds according to the invention are, in particular, eminently suitable for use in light-generating systems, such as, for example, displays or illumination.

The use of Ln complexes of the formula (I) or (II) as emitter materials in OLEDs gives rise to a number of advantages. In the case of use of 100% or highly concentrated emitter layers comprising materials of the formula (I) and/or formula (II) according to the invention, concentration variations cannot occur during manufacture of the devices. It is furthermore possible to provide the emitter in crystalline layers. Furthermore, high luminous densities can be achieved at the same time as high current densities with the emitter molecules according to the invention. In addition, relatively high efficiency (quantum efficiency) can also be achieved at the same time as high current densities. This applies, in particular, to Ce³⁺ complexes, which have short-lived fluorescence emission (≈60 ns). The complexes of the formulae (I) and (II) can also be employed in accordance with the invention dissolved in suitable matrices in low doping (for example 2-10%).

In a further preferred embodiment of the invention, complexes of the formula (I) or/and of the formula (II) are employed in low concentration in the emitter layer, achieving monomer emission in the OLEO device. The complexes of the formula (I) or/and (II) are present in the emitter layer, in particular, in an amount of greater than 2% by weight, in particular greater than 4% by weight and up to 10% by weight, in particular up to 8% by weight, based on the total weight of the emitter layer.

In a further preferred embodiment, three or at least two different complexes of the formula (I) or (II) are employed in accordance with the invention in the light-emitting device. Emitter layers of this type comprising a plurality of complexes enable, in particular, mixed-colour light to be obtained.

The complexes of the formula (I) or (II) employed in accordance with the invention as emitter molecules are, in particular, luminescent compounds. The complexes have a central atom which is a lanthanoid. The central atom is preferably Ce³⁺, Eu³⁺, Tb³⁺ or Nd³⁺. Complexes containing Nd³⁺ as central atom give rise, in particular, to emitters for the infrared region. A suitable choice of the central atom enables interesting regions of the spectrum to be covered in accordance with the invention. Preference is furthermore given to blue emitters, in particular containing Ce³⁺ as central atom.

R¹ is preferably a pyrazolyl radical. Whereas R⁵ may be H, it is preferred for R⁵ to represent a radical which is not H. R⁵ is particularly preferably a triazolyl radical.

The radicals R², R³, R⁴, R⁶ and R⁷ each represent, independently of one another, hydrogen, halogen or a hydrocarbon group, which may optionally contain heteroatoms and/or be substituted.

The heteroatoms are selected, in particular, from O, S, N, P, Si, Se, F, Cl, Br and/or I. The radicals R¹ to R⁷ preferably each have 0 to 50, in particular 0 to 10, and still more preferably 0 to 5, heteroatoms. In some embodiments, the radicals R¹ to R⁷ each have at least one, in particular at least two, heteroatoms. The heteroatoms here can be in the skeleton or part of substituents. In an embodiment, the radicals R¹ to R⁷ are a hydrocarbon group which has one or more substituents (functional groups). Suitable substituents or functional groups are, for example, halogen, in particular F, CI, Br or I, alkyl, in particular C₁ to C₂₀, still more preferably C₁ to C₆ alkyl, aryl, O-alkyl, O-aryl, S-aryl, S-alkyl, P-alkyl₂, P-aryl₂, N-alkyl₂ or N-aryl₂ or other donor or acceptor groups. In many cases, it is preferred for at least one of the radicals R¹ to R⁷ to contain at least one fluorine in order to increase the volatility of the complex.

A hydrocarbon group here is preferably an alkyl, alkenyl, alkynyl, aryl or heteroaryl group, in particular an alkyl, aryl or heteroaryl group.

Unless indicated otherwise, the term alkyl- or alk-, as used herein, in each case independently preferably denotes a C₁-C₂₀, in particular a C₁-C₆ hydrocarbon group. The term aryl- preferably denotes an aromatic system having 5 to, for example, 20 C atoms, in particular having 6 to 10 C atoms, where C atoms may optionally be replaced by heteroatoms (for example N, S, O).

It is particularly preferred for all substituents R², R³, R⁴, R⁶ and R⁷ to represent hydrogen or halogen, i.e. substituents which do not cause steric hindrance.

In a preferred embodiment, the emitter layer comprises complexes of the formula (I) and/or of the formula (II) in a concentration of greater than 1% by weight, based on the total weight of the emitter layer, in particular greater than 2% by weight, more preferably greater than 5% by weight and up to 10% by weight, in particular up to 8% by weight. However, it is also possible to provide emitter layers which virtually completely or completely comprise complexes of the formula (I) or/and of the formula (II) and in particular>80% by weight and most preferably>90% by weight, in particular>95% by weight, more preferably>99% by weight. In a further embodiment, the emitter layer consists completely, i.e. to the extent of 100%, of complexes of the formula (I) or/and of the formula (II). In particular in the case of 100% of the complexes in the emitter layer, no concentration variations occur during manufacture or they have only a slight effect in highly concentrated systems. Furthermore, a high luminous density can be achieved at the same time as high current densities by means of such concentrated emitter layers, and high efficiency, i.e. a high quantum efficiency, can be achieved.

The present invention provides, inter alia, the following advantages:
high colour purity through narrow emission line widths,
high thermal stability,
high long-term stability,
good chemical stability to oxygen and water,
good solubility in polar solvents and thus highly suitable for doping in various polymer matrix materials (good incorporation into the emitter layer),
simple application by means of spin-coating processes, printing processes and ink-jet printing processes,
large choice of various solvents for the said processes, therefore avoidance of incipient dissolution of the underlying layers,
simple achievement of white emission colours through the use of balanced mixtures of various lanthanoid ions,
significant manufacturing advantages,
blue emission of Ce complexes having an extremely short emission decay time (≈60 ns). High current densities can thus be used.

The complexes employed in accordance with the invention as emitters can be tuned in the wavelength range in a simple manner through the choice of suitable matrix materials and slightly, in particular, through the choice of electron-withdrawing or -donating substituents.

Preference is given to the use of compounds which exhibit emission at a temperature of>70° C. and at temperatures of particularly preferably above 100° C.

Particular preference is given in accordance with the invention to the compounds
cerium(III) tetrakis(pyrazolyl)borate,
europium(III) tetrakis(pyrazolyl)borate,
terbium(III) tetrakis(pyrazolyl)borate and
neodymium(III) tetrakis(pyrazolyl)borate.

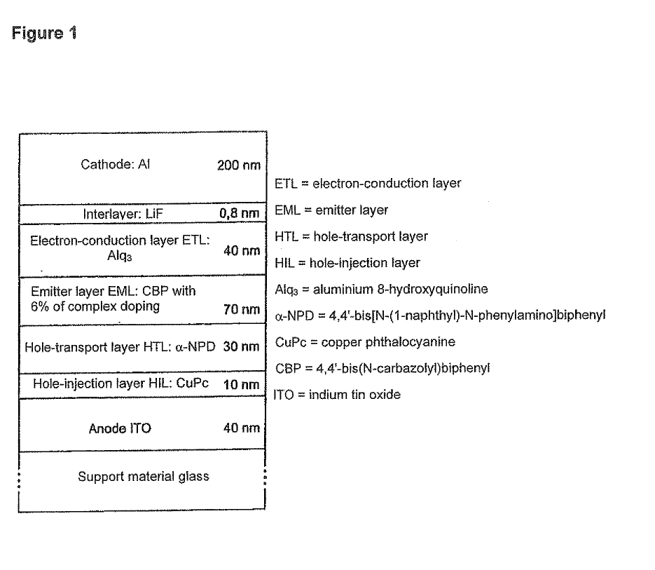

The way in which an embodiment of the light-emitting devices according to the invention works is shown diagrammatically in FIG. 1. The device comprises at least one anode, a cathode and an emitter layer. One or both of the electrodes used as cathode or anode advantageously have a transparent design, so that the light can be emitted through this electrode. The transparent electrode material used is preferably indium tin oxide (ITO). A transparent anode is particularly preferably employed. The other electrode may likewise be formed from a transparent material, but may also be formed from another material having a suitable electron work function if it is intended for light to be emitted through only one of the two electrodes. The second electrode, in particular the cathode, preferably consists of a metal having a low electron work function and good electrical conductivity, for example aluminium, silver, or an Mg/Ag or Ca/Ag alloy.

An emitter layer is arranged between the two electrodes. This may be in direct contact with the anode and cathode, or in indirect contact, where indirect contact means that further layers are present between the cathode or anode and the emitter layer, so that the emitter layer and the anode or/and cathode do not touch one another, but instead are in electrical contact with one another via further interlayers. On application of a voltage, for example a voltage of 3-20 V, in particular 5-10 V, negatively charged electrons exit from the cathode, for example a conductive metal layer, for example an aluminium cathode, and migrate in the direction of the positive anode. Positive charge carriers, so-called holes, in turn migrate from this anode in the direction of the cathode. In accordance with the invention, the organometallic complexes of the formulae (I) and (H) are located as emitter molecules in the emitter layer arranged between the cathode and anode. The migrating charge carriers, i.e. a negatively charged electron and a positively charged hole, recombine at the emitter molecules or in their vicinity, resulting in neutral, but energetically excited states of the emitter molecules. The excited states of the emitter molecules then release their energy as light emission.

The light-emitting devices according to the invention can be produced by vacuum deposition so long as the emitter materials are sublimable. Alternatively, build-up via wet-chemical application is also possible, for example via spin-coating processes, via ink-jet printing or via screen-printing processes. The build-up of OLED devices is described in detail, for example, in US 2005/0260449 Al and in WO 2005/098988 A1.

The light-emitting devices according to the invention can be manufactured by means of the vacuum sublimation technique and may comprise a plurality of further layers, in particular an electron-injection layer and an electron-conduction layer (for example Alq₃=Al-8-hydroxyquinoline or β-Alq=Al bis(2-methyl-8-hydroxyquinolato)-4-phenylphenolate) and/or a hole-injection layer (for example CuPc=Cu phthalocyanine) and hole-conduction layer (for example α-NPD=N,N′-diphenyl-NN-bis(1-methyl)-1,1′-biphenyl-4,4′-diamine). However, it is also possible for the emitter layer to take on functions of the hole- or electron-conduction layer (suitable materials have been explained on pages 9/10).

The emitter layer preferably consists of an organic matrix material having a singlet S₀-triplet T₁ energy gap which is sufficiently large for the respective emission colour (depending on the Ln central ion selected), for example UGH, PVK (polyvinylcarbazole) derivatives, CBP (4,4′-bis(9-carbazolyl)biphenyl) or other matrix materials. The emitter complex is doped into this matrix material, for example preferably to the extent of 1 to 10 per cent by weight.

In specific cases, for example where Ln³⁺=Ce³⁺, the emitter layer may also be achieved without a matrix by applying the corresponding complex as 100% material. A corresponding embodiment is described below.

In a particularly preferred embodiment, the light-emitting device according to the invention also has a CsF interlayer between the cathode and the emitter layer or an electron-conductor layer. This layer has, in particular, a thickness of 0.5 nm to 2 nm, preferably about 1 nm. This interlayer predominantly causes a reduction in the electron work function.

The light-emitting device is furthermore preferably applied to a substrate, for example a glass substrate.

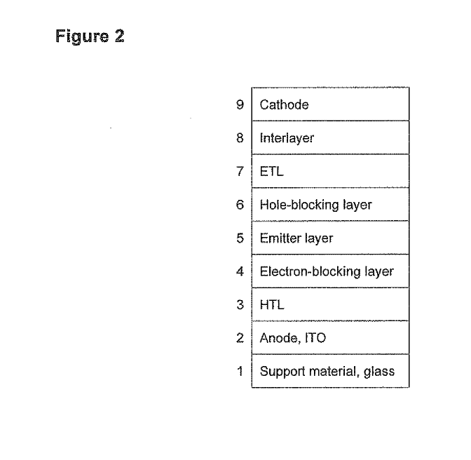

In a particularly preferred embodiment, an OLED construction for a sublimable emitter according to the invention also comprises, besides an anode, emitter layer and cathode, at least one, in particular a plurality of and particularly preferably all of the layers mentioned below and depicted in FIG. 2.

The entire construction is preferably located on a support material, for which purpose, in particular, glass or any other solid or flexible transparent material can be employed. The anode, for example an indium tin oxide (ITO) anode, is arranged on the support material. A hole-transport layer (HTL), for example α-NPD (N,N′-diphenyl-N,N′-bis(1-methyl)-1,1′-biphenyl-4,4′-diamine), is arranged on the anode and between the emitter layer and anode. The thickness of the hole-transport layer is preferably 10 to 100 nm, in particular 30 to 50 nm. Further layers which improve hole injection, for example a copper phthalocyanine (CuPc) layer, may be arranged between the anode and the hole-transport layer. This layer is preferably 5 to 50 nm, in particular 8 to 15 nm thick. An electron-blocking layer, which ensures that electron transport to the anode is suppressed since a current of this type would only cause ohmic losses, is preferably applied to the hole-transport layer and between the hole-transport and emitter layers. The thickness of this electron-blocking layer is preferably 10 to 100 nm, in particular 20 to 40 nm. This additional layer may be omitted, in particular, if the HTL layer is already intrinsically a poor electron conductor.

The next layer is the emitter layer which comprises or consists of the emitter material according to the invention. In the embodiment using sublimable emitters, the emitter materials are preferably applied by sublimation. The layer thickness is preferably between 40 nm and 200 nm, in particular between 70 nm and 100 nm. The emitter material according to the invention may also be co-evaporated together with other materials, in particular with matrix materials. For emitter materials according to the invention which emit in the green or red, common matrix materials, such as CBP (4,4′-bis(N-carbazolyl)biphenyl), are suitable. However, it is also possible for complexes of the formula (I), in particular where Ln=Ce, to build up a 100% emitter material layer. For emitter materials according to the invention which emit in the blue, for example where Ln=Ce, UGH matrix materials are preferably employed (cf. M. E. Thompson et al., Chem. Mater. 2004, 16, 4743). Co-evaporation can likewise be used for the generation of mixed-colour light on use of compounds according to the invention containing different central metal ions.

A hole-blocking layer, which reduces ohmic losses, which may arise due to hole currents towards the cathode, is preferably applied to the emitter layer. This hole-blocking layer is preferably 10 to 50 nm, in particular 15 to 25 nm thick. A suitable material for this purpose is, for example, BCP (4,7-diphenyl-2,9-dimethylphenanthroline, also known as bathocuproin). An electron-transport layer (ETL) comprising electron-transport material is preferably applied to the hole-blocking layer and between this layer and the cathode. This layer preferably consists of vapour-depositable Alq₃ having a thickness of 10 to 100 nm, in particular 30 to 50 nm. An interlayer, for example comprising CsF or LIF, is preferably applied between the ETL and the cathode. This interlayer reduces the electron-injection barrier and protects the ETL. This layer is generally applied by vapour deposition. The interlayer is preferably very thin, in particular 0.5 to 2 nm, more preferably 0.8 to 1.0 nm thick. Finally, a conductive cathode layer is applied by vapour deposition, in particular having a thickness of 50 to 500 nm, more preferably 100 to 250 nm. The cathode layer preferably consists of Al, Mg/Ag (in particular in the ratio 10:1) or other metals. Voltages between 3 and 15 V are preferably applied to the OLED construction described for a sublimable emitter according to the invention.

The OLED may also be partially manufactured by wet-chemical methods, for example with the following structure: glass substrate, transparent ITO layer (comprising indium tin oxide), for example PEDOT/PSS (for example 40 nm), 100% complex according to the invention, particularly where Ln=Ce, of the formula (I) (for example 10 to 80 nm) or complexes of the formula (I) or formula (II) doped (for example 1%, in particular 4% to 10%) into a suitable matrix (for example 40 nm), vapour-deposited Alq₃ (for example 40 nm), vapour-deposited LiF or CsF protective layer (for example 0.8 nm), vapour-deposited metal cathode Al or Ag or Mg/Ag (for example 200 nm).

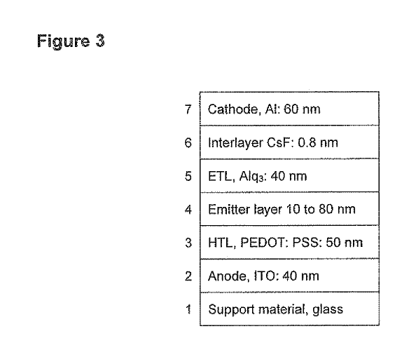

An OLED design for a soluble emitter according to the invention particularly preferably has the structure described below and depicted in FIG. 3, but comprises at least one, more preferably at least two and most preferably all of the layers mentioned below.

The device is preferably applied to a support material, in particular glass or another solid or flexible transparent material. An anode, for example an indium tin oxide anode, is applied to the support material. The layer thickness of the anode is preferably 10 nm to 100 nm, in particular 30 to 50 nm. A hole-transport layer (HTL) comprising a hole-conductor material, in particular a hole-conductor material which is water-soluble, is applied to the anode and between the anode and emitter layer. A hole-conductor material of this type is, for example, PEDOT/PSS (polyethylenedioxythiophene/polystyrene-sulfonic acid). The layer thickness of the HTL is preferably 10 to 100 nm, in particular 40 to 60 nm. Next, the emitter layer (EML) which comprises a soluble emitter according to the invention is applied. The material may be dissolved in a solvent, for example in acetone, dichloromethane or acetonitrile. Dissolution of the underlying PEDOT/PSS layer can thus be avoided. The emitter material according to the invention can be employed in low concentration, for example 2 to 10% by weight, for complexes of the formula (I) and formula (II), but can also be employed in higher concentration or as 100% layer. The emitter material is applied with a low, high or moderate degree of doping in a suitable polymer layer (for example PVK=polyvinylcarbazole).

A layer comprising electron-transport material is preferably applied to the emitter layer, in particular having a layer thickness of 10 to 80 nm, more preferably 30 to 50 nm. A suitable material for the electron-transport material layer is, for example, Alq₃, which can be applied by vapour deposition. Next, a thin interlayer which reduces the electron-injection barrier and protects the ETL is preferably applied. This layer preferably has a thickness of between 0.5 and 2 nm, in particular between 0.5 and 1.0 nm, and preferably consists of CsF or LiF. This layer is generally applied by vapour deposition. For a further simplified OLED structure, the ETL and/or the interlayer may optionally be omitted.

Finally, a conductive cathode layer is applied, in particular by vapour deposition. The cathode layer preferably consists of a metal, in particular Al or Mg/Ag (in particular in the ratio 10:1).

Voltages of 3 to 15 V are preferably applied to the device.

The invention furthermore relates to the use of a compound of the formula (I) or (II) as defined herein as emitter in a light-emitting device, in particular in an organic light-emitting device.

The invention furthermore relates to Ln complexes of the formula (I) or (II) as defined hereinbefore.

The emission colour can be adjusted, in particular, through the choice of the central atom. For example, Ce³⁺ complexes of the formula (I) or (II) have blue emission, in particular emission at 520 nm, more preferably≦500 nm and>380 nm, in particular>430 nm. Complexes containing Nd³⁺ as central atom have, in particular, emission in the infrared, in particular having a wavelength>600 nm, more preferably>700 nm and still more preferably>780 nm and up to 1 mm, preferably up to 500 μm.

It is also possible in accordance with the invention to provide two, three or more different emitter complexes of the formula (I) or (II) in a single emitter layer. Mixed colours and in particular white light can thus be generated.

Besides their emitter properties, the complexes according to the invention facilitate further interesting applications. Thus, it has been observed that complexes of the formula (I) or (II) in which Ln=Ce³⁺ or Gd³⁺ have very high energy differences between the electronic ground state and the lowest excited state. Furthermore, the energetic positions of the HOMOs in such complexes are at very low energies compared with those of many other compounds. Layers which consist predominantly, in particular>90%, more preferably>95% and in particular completely, of compounds of the formula (I) or (II) where Ln=Ce³⁺ or Gd³⁺ can therefore also be employed as hole-blocking layers or as matrix materials for the construction of emitter layers. Owing to the very low position of the HOMO, these complexes can also be employed in hole-blocking layers.

The invention therefore furthermore relates to a hole-blocking layer comprising a complex of the formula (I) or (II)

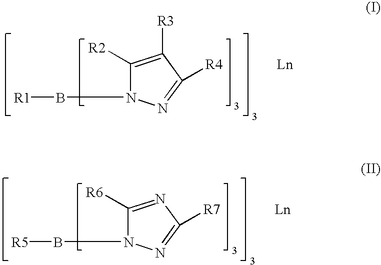

in which

Ln=Ce³⁺ or Gd³⁺,

R1=a pyrazolyl, triazolyl, heteroaryl, alkyl, aryl, alkoxy, phenolate, amine or amide group, which may be substituted or unsubstituted, or

R⁵=R¹ or H, and

R², R³, R⁴, R⁶, R⁷=H, halogen or a hydrocarbon group, which may contain heteroatoms or/and be substituted.

Owing to the energetic states of complexes of the formula (I) or (II) where Ln=Ce³⁺ or Gd³⁺, these can also be employed as matrix material. The invention therefore furthermore relates to a matrix material for an emitter layer comprising at least one complex of the formula (I) or (II)

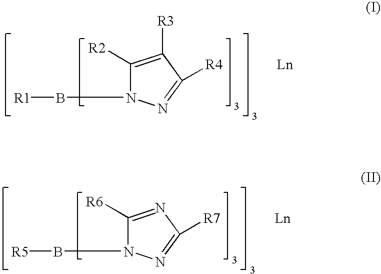

in which

Ln=Ce³⁺ or Gd³⁺,

R1=a pyrazolyl, triazolyl, heteroaryl, alkyl, aryl, alkoxy, phenolate, amine or amide group, which may be substituted or unsubstituted, or

R⁵=R¹ or H, and

R², R³, R⁴, R⁶, R⁷=H, halogen or a hydrocarbon group, which may contain heteroatoms or/and be substituted.

In this application, the emission does not take place from the complexes of the formula (I) or (II) where Ln=Ce³⁺ or Gd³⁺, but instead from other emitter complexes. Suitable emitter complexes may be doped into the matrix material. The matrix material according to the invention is preferred for blue emitters. For matrix materials comprising Gd complexes, any desired blue emitters may be doped in. In the case of Ce complex matrix materials, emitters which have a somewhat lower emission energy than the Ce complex emission are advantageously doped in. In particular, the matrix materials according to the invention comprising Gd or Ce complexes may replace conventional matrix materials, for example the UGH matrix materials mentioned hereinbefore. The matrix materials according to the invention, i.e. layers which consist of Gd or Ce complexes of the formula (I) or (II), have significantly higher long-term stability than the matrix materials known to date, in particular than matrix materials known to date for blue emitters.

Matrix materials comprising Gd complexes additionally have a significantly higher energy gap than most matrix materials known to date for blue emitters.

In a particularly preferred embodiment, a complex of the formula (I) or (II) containing Ce³⁺ as central atom is employed in accordance with the invention as emitter, and a further complex of the formula (I) or (II) containing Gd as central atom is employed in accordance with the invention as matrix material. The invention therefore also relates to an emitter layer, in particular for a light-emitting device, comprising

(i) a matrix material comprising at least one complex of the formula (I) or (II)

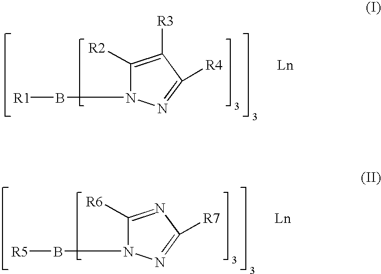

in which

Ln=Gd³⁺,

R1=a pyrazolyl, triazolyl, heteroaryl, alkyl, aryl, alkoxy, phenolate, amine or amide group, which may be substituted or unsubstituted, or

R⁵=R¹ or H, and

R², R³, R⁴, R⁶, R⁷=H, halogen or a hydrocarbon group, which may contain heteroatoms or/and be substituted, and

(ii) as emitter, at least one complex of the formula (I) or (II)

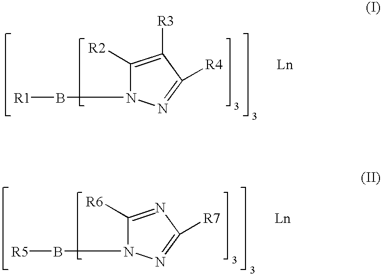

in which

Ln=Ce³⁺,

R1=a pyrazolyl, triazolyl, heteroaryl, alkyl, aryl, alkoxy, phenolate, amine or amide group, which may be substituted or unsubstituted, or

R⁵=R¹ or H, and

R², R³, R⁴, R⁴, R⁶, R⁷H, halogen or a hydrocarbon group, which may contain heteroatoms or/and be substituted.

In this application, the Ce complex is the emitter, while the Gd complex serves as matrix material. A preferred concentration for the Ce emitter complex here is 1 to 10% by weight, based on the total weight of the emitter layer.

The invention is explained in greater detail by the attached drawings and the following examples.

FIG. 1 shows an example of an OLED device comprising complexes according to the invention which can be produced by means of the vacuum sublimation technique.

FIG. 2 shows an example of a differentiated, highly efficient OLED device comprising sublimable emitter materials according to the invention.

FIG. 3 shows an example of an OLED device for emitters according to the invention which are to be applied by wet-chemical methods. The layer-thickness data should be regarded as illustrative values.

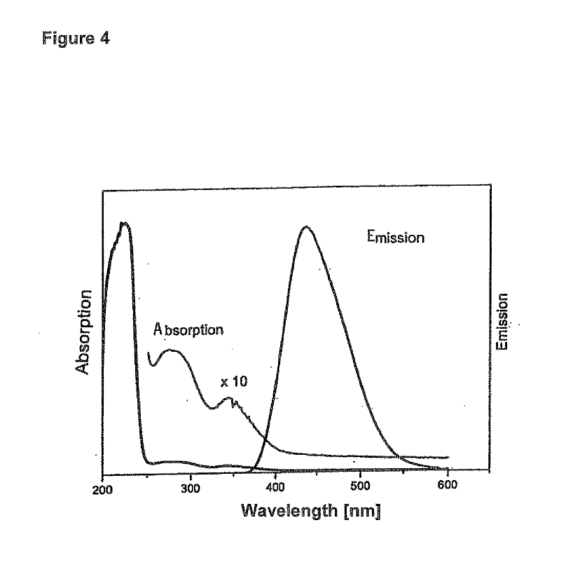

FIG. 4 shows the absorption and emission spectrum of Ce[B(pz)₄]₃ (blue emitter). The conditions were as follows: excitation: 300 nm, solution in EtOH; temperature: 300 K.

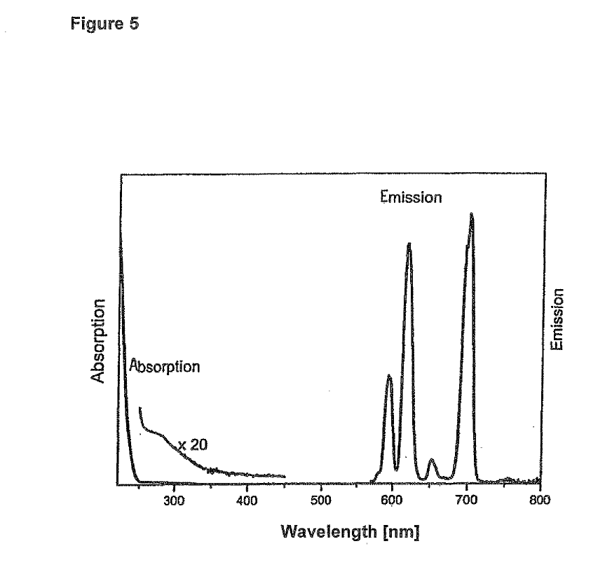

FIG. 5 shows the absorption and emission spectrum of Eu[B(pz)₄]₃ (red emitter).

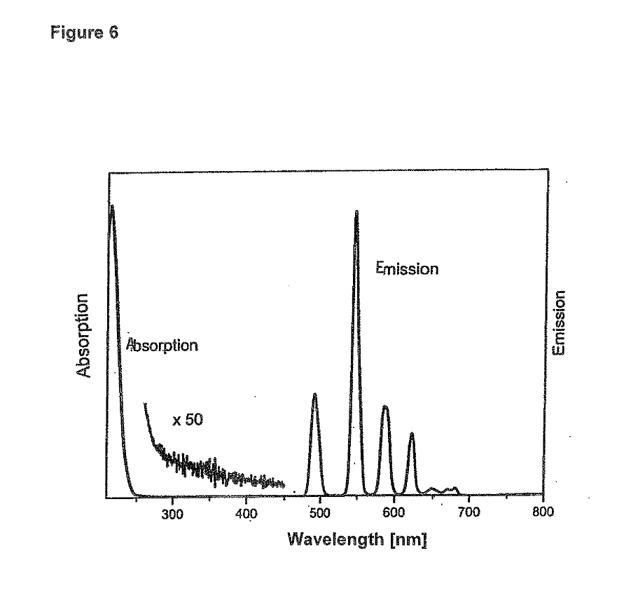

FIG. 6 shows the absorption and emission spectrum of Tb[B(pz)₄]₃ (green emitter). The conditions were as follows: excitation: 260 nm, solution in EtOH, 300 K; filter: 375.

### EXAMPLES

Potassium tetrakis(pyrazolyl)borate is obtainable from Acros, potassium hydro[tris(triazolyl)]borate and potassium tetrakis(triazolyl)borate are prepared from KBH₄ and triazole, derivatised borate ligands conforming to formula (I) and formula (II) can be obtained by various synthetic strategies.

Three simple examples are intended to explain the invention conforming to formula (I), R1=pz (pz=pyrazolyl):

LnCl₃ n·H₂O (0.66 mmol) (Ln=Ce³⁺, Eu³⁺ and Tb³⁺) and K[B(pz)₄] (2.0 mmol) are dissolved in MeOH (10 ml). A finely crystalline, white precipitate is formed. The solution is filtered, and the solvent is removed in vacuo. The residue is extracted with DCM (10 ml). The solution is evaporated, and the product is precipitated using pentane and dried in vacuo.

| | C | | H | | N | |
|---|---|---|---|---|---|---|
| | calc. | found | calc. | found | calc. | found |
| Ce[B(pz)₄]₃ | 44.24 | 43.62 | 3.71 | 3.69 | 34.39 | 32.65 |
| Eu[B(pz)₄]₃ | 43.17 | 43.08 | 3.67 | 3.76 | 33.98 | 33.67 |
| Tb[B(pz)₄]₃ | 43.40 | 42.90 | 3.64 | 3.32 | 33.74 | 32.86 |

1-26. (canceled)

27. A light-emitting device comprising
(i) an anode;
(ii) a cathode; and
(iii) an emitter layer arranged between and in direct or indirect contact with said anode and said cathode, said emitter layer comprising at least one complex of formula (I) or (II) 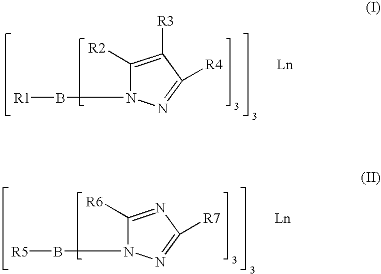
wherein
Ln is Ce³⁺, Pr³⁺, Nd³⁺, Pm³⁺, Sm³⁺, Eu³⁺, Gd³⁺, Tb³⁺, Dy³⁺, Ho³⁺, Er³⁺, Tm³⁺, Yb³⁺, or Lu³⁺;
R1 is an optionally substituted pyrazolyl, triazolyl, heteroaryl, alkyl, aryl, alkoxy, phenolate, amine, or amide group;
R5 is H or an optionally substituted pyrazolyl, triazolyl, heteroaryl, alkyl, aryl, alkoxy, phenolate, amine, or amide group; and
R2, R3, R4, R6, and R7 are H, halogen, or an optionally substituted hydrocarbon group, wherein said optionally substituted hydrocarbon group optionally contains heteroatoms.

28. The light-emitting device of claim 27, wherein said light-emitting device further comprises a hole-conductor layer and/or an electron-conductor layer.

29. The light-emitting device of claim 27, wherein said light-emitting device further comprises a CsF or LiF interlayer.

30. The light-emitting device of claim 27, wherein said light-emitting device is arranged on a substrate.

31. The light-emitting device of claim 27, wherein the complex present in said emitter layer is a lanthanoid emitter.

32. The light-emitting device of claim 27, wherein R2, R3, R4, R6, and R7 each, independently of one another, are hydrogen or halogen.

33. The light-emitting device of claim 27, wherein said emitter layer comprises complexes of formula (I) and/or (II) in a concentration of from 1 to 100% by weight, based on the total weight of said emitter layer.

34. The light-emitting device of claim 27, wherein the proportion of complexes of formula (I) and/or (II) in said emitter layer is greater than 80% by weight, based on the total weight of the emitter layer.

35. The light-emitting device of claim 27, wherein the proportion of complexes of formula (I) and/or (II) in said emitter layer is greater than 10% by weight and up to 80% by weight, based on the total weight of the emitter layer.

36. The light-emitting device of claim 27, wherein the proportion of complexes of formula (I) and/or (II) in said emitter layer is greater than 2% by weight and up to 10% by weight, based on the total weight of the emitter layer.

37. The light-emitting device of claim 35, wherein the complexes of formula (I) or (II) in said emitter layer are in the form of monomers.

38. The light-emitting device of claim 27, wherein said light-emitting device comprises crystalline and/or quasi-crystalline layers comprising a complex of formula (I) or (II) 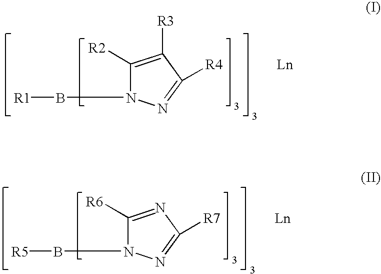
wherein
Ln is Ce³⁺, Pr³⁺, Nd³⁺, Pm³⁺, Sm³⁺, Eu³⁺, Gd³⁺, Tb³⁺, Dy³⁺, Ho³⁺, Er³⁺, Tm³⁺, Yb³⁺, or Lu³⁺;
R1 is an optionally substituted pyrazolyl, triazolyl, heteroaryl, alkyl, aryl, alkoxy, phenolate, amine, or amide group;
R5 is H or an optionally substituted pyrazolyl, triazolyl, heteroaryl, alkyl, aryl, alkoxy, phenolate, amine, or amide group; and
R2, R3, R4, R6, and R7 are H, halogen, or an optionally substituted hydrocarbon group, wherein said optionally substituted hydrocarbon group optionally contains heteroatoms.

39. The light-emitting device of claim 27, wherein said light-emitting device is a display and/or an illumination device.

40. The light-emitting device of claim 27, wherein Ln is Ce³⁺ and said complex of formula (I) or (H) is a fluorescence emitter having a short emission decay time.

41. A process for producing the light-emitting device of claim 27, comprising introducing at least one complex of formula (I) or (II) into said emitter layer by vacuum sublimation.

42. A process for producing the light-emitting device of claim 27, comprising introducing at least one complex of formula (I) or (II) into said emitter layer by wet-chemical methods.

43. The light-emitting device of claim 27, wherein said emitter layer comprises two or three or more complexes of formula (I) or (II) for the generation of white light.

44. The light-emitting device of claim 27, wherein Ln is Ce³⁺ and said light-emitting device is a blue-emitting OLED.

45. The light-emitting device of claim 27, wherein Ln is Nd³⁺ and said light-emitting device is an infrared-emitting OLED.

46. A hole-blocking layer comprising a complex of formula (I) or (II) 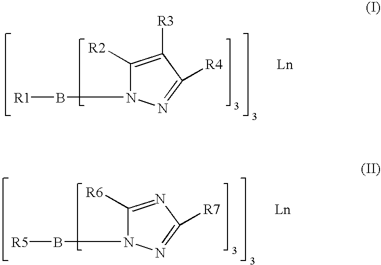
wherein
Ln is Ce³⁺ or Gd³⁺;
R1 is an optionally substituted pyrazolyl, triazolyl, heteroaryl, alkyl, aryl, alkoxy, phenolate, amine, or amide group;
R5 is H or an optionally substituted pyrazolyl, triazolyl, heteroaryl, alkyl, aryl, alkoxy, phenolate, amine, or amide group; and
R2, R3, R4, R6, and R7 are H, halogen, or an optionally substituted hydrocarbon group, wherein said optionally substituted hydrocarbon group optionally contains heteroatoms.

47. A matrix material for an emitter layer comprising at least one complex of formula (I) or (II) 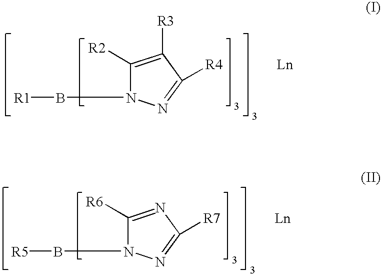
in which
Ln is Ce³⁺ or Gd³⁺;
R1 is an optionally substituted pyrazolyl, triazolyl, heteroaryl, alkyl, aryl, alkoxy, phenolate, amine, or amide group;
R5 is H or an optionally substituted pyrazolyl, triazolyl, heteroaryl, alkyl, aryl, alkoxy, phenolate, amine, or amide group; and
R2, R3, R4, R6, and R7 are H, halogen, or an optionally substituted hydrocarbon group, wherein said optionally substituted hydrocarbon group optionally contains heteroatoms.

48. The matrix material of claim 46, wherein said matrix material is doped with an emitter complex.

49. An emitter layer comprising
(i) a matrix material comprising at least one complex of formula (I) or (II) 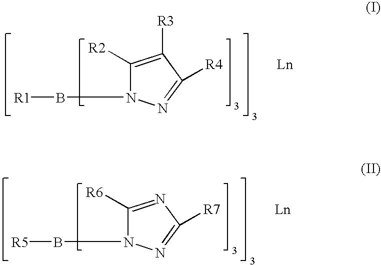
wherein
Ln is Gd³⁺;
R1 is an optionally substituted pyrazolyl, triazolyl, heteroaryl, alkyl, aryl, alkoxy, phenolate, amine, or amide group;
R5 is H or an optionally substituted pyrazolyl, triazolyl, heteroaryl, alkyl, aryl, alkoxy, phenolate, amine, or amide group; and
R2, R3, R4, R6, and R7 are H, halogen, or an optionally substituted hydrocarbon group, wherein said optionally substituted hydrocarbon group optionally contains heteroatoms;
and
(ii) as emitter, at least one complex of formula (I) or (II) 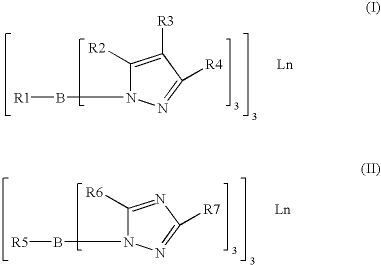
wherein
Ln is Ce³⁺;
R1 is an optionally substituted pyrazolyl, triazolyl, heteroaryl, alkyl, aryl, alkoxy, phenolate, amine, or amide group;
R5 is H or an optionally substituted pyrazolyl, triazolyl, heteroaryl, alkyl, aryl, alkoxy, phenolate, amine, or amide group; and
R2, R3, R4, R6, and R7 are H, halogen, or an optionally substituted hydrocarbon group, wherein said optionally substituted hydrocarbon group optionally contains heteroatoms.

50. A complex of formula (I) or (II) 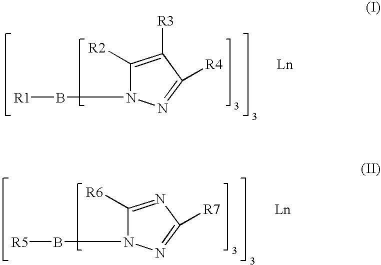
wherein
Ln is Ce³⁺, Pr³⁺, Nd³⁺, Pm³⁺, Sm³⁺, Eu³⁺, Gd³+, Tb³⁺, Dy³⁺, Ho³⁺, Er³⁺, Tm³⁺, Yb³⁺, or Lu³⁺;
R1 is an optionally substituted pyrazolyl, triazolyl, heteroaryl, alkyl, aryl, alkoxy, phenolate, amine, or amide group;
R5 is H or an optionally substituted pyrazolyl, triazolyl, heteroaryl, alkyl, aryl, alkoxy, phenolate, amine, or amide group; and
R2, R3, R4, R6, and R7 are H, halogen, or an optionally substituted hydrocarbon group, wherein said optionally substituted hydrocarbon group optionally contains heteroatoms.
